(19) United States
(12) Patent Application Publication
(10) Pub. No.: US 2016/0219871 A1
(43) Pub. Date: Aug. 4, 2016

(54) CROSS-LINKED HYDROPHILIC POLYMER COATED SEEDS AND METHODS OF PREPARATION THEREOF

(71) Applicants: Naihong LI, Sunnyvale, CA (US); Jen-Chieh WU, Sunnyvale, CA (US)

(72) Inventors: Naihong LI, Sunnyvale, CA (US); Jen-Chieh WU, Sunnyvale, CA (US)

(21) Appl. No.: 15/021,671

(22) PCT Filed: Sep. 19, 2014
(86) PCT No.: PCT/CA2014/050906

§ 371 Date: Mar. 11, 2016

Related U.S. Application Data
(60) Provisional application No. 61/880,088, filed on Sep. 19, 2013.

(51) Int. Cl. A01N 25/00

(52) U.S. Cl. CPC A01N 25/00

(57) ABSTRACT

Seed coatings may be used in agriculture to prevent desiccation and provide protection from fungus, insects and enhance nutrient availability. Seeds coated with a coating of hydrophilic polymer materials, such as cross-linked polyacrylate and cellulose materials, and methods for preparation thereof are described. Seed coatings including hydrophilic polymer materials may also include fertilizers, insecticides, fungicides and pesticides.

### RELATED APPLICATIONS

This application claims priority to U.S. patent application Ser. No. 61/880,088, filed Sep. 19, 2013, the contents of which are hereby incorporated by reference in their entirety. This application is related to Patent Cooperation Treaty (PCT) Patent Application No. PCT/US2011/059837 filed Nov. 8, 2011 and PCT Patent Application No. PCT/CA2013/050673 filed Aug. 30, 2013, which applications are hereby incorporated by reference in their entirety.

### FIELD OF THE INVENTION

The present invention relates generally to cross-linked hydrophilic polymer coated seeds and methods of preparation thereof. More particularly, the present invention relates to seeds coated by cross-linked hydrophilic polymers such as hydrogels and/or celluloses, for applications such as in agriculture and/or horticulture, and methods of preparation and manufacturing therefor.

### BACKGROUND TO THE INVENTION

Seed treatment is a large industry. Approximate ninety percent of food crops are grown from seeds. A major challenge for successful production from sown seeds is pathogens in the seed stock, so seed treatments have traditionally been developed focused on pathogen control, which can impact crop yield. Due in part to recent climate change, there is a growing demand for agriculture from seed planted in a dry or otherwise less than optimal planting environment where soil moisture is limited. For example, in recent times the state of California has experienced worsening drought conditions, impacting traditionally high intensity agricultural areas. During drought or other dry conditions, sown seeds are typically vulnerable at the germination stage.

In some agricultural regions and particularly for some high value crops, transplanting seedling plants is commonly used, such as in California, where virtually all of the commercially produced tomato and strawberry crops are transplanted into commercial fields rather than seed sown directly in fields. Other vegetables can typically be either transplanted or seed sown depending on the region and season. Some other crops with a large amount of transplant production are cruciferous crops (such as broccoli, cabbage or cauliflower) with over 210 acres in production worth $48 million, peppers with 200 acres in production worth $28 million and lettuce and other greens with 180 acres in production worth $43 million. As the seed industry continues to improve the quality and traits of plants, each seed is going to become even more valuable and the use of transplants is likely to increase.

Seed coatings are widely used in agriculture to prevent desiccation and provide protection from fungus, insects and enhance nutrient availability. However, there remains a desire for improved seed coatings for providing improved germination characteristics for plants, and in particular for high value crop plants which may be used for transplant planting in commercial farm production, for example. Therefore, seed treatments including polymeric hydrogels capable of absorbing significant amounts of water have been desired such as for improving seed germination performance, such as for improving seed performance in low moisture environments. However, a technical hurdle using traditional coating methods for coating seeds with hydrogel hydrogels which has affected some attempts at producing hydrogel coated seeds is the bridging of the coating material. In such cases bridging of the coating may typically deteriorate the seed coating quality and negatively affect following seed processing. Therefore, improved coating methods for hydrogel coated seeds and seeds so coated are desired.

### SUMMARY OF THE INVENTION

According to one embodiment of the present invention, a hydrophilic polymer coated seed is provided comprising a suitable plant seed, coated with suitably thick coating consisting of at least one cross-linked hydrophilic polymer. In a particular embodiment, the at least one suitable cross-linked hydrophilic hydrogel material may comprise a cross-linked potassium polyacrylate hydrogel. In another particular embodiment, the at least one suitable cross-linked hydrophilic hydrogel material may comprise an enzymatically cross-linked cellulose hydrogel. In an alternate embodiment, the coating may optionally comprise at least one cross-linked hydrophilic cellulose material.

According to another embodiment of the present invention, a method of preparation of a cross-linked hydrophilic polymer coated seed is provided, wherein the method comprises the steps of:

a) providing a suitable plant seed;

b) preparing a suitable cross-linked hydrophilic polymer solution or mixture;

c) coating the seed with a suitable or desired thickness of the cross-linked hydrophilic polymer solution or mixture; and

d) drying the coated seed to a suitable or desired moisture content of the cross-linked hydrophilic polymer coating.

In a further embodiment of the present invention, a method of preparation of a cross-linked hydrophilic polymer coated seed is provided, wherein the method comprises the steps of:

a) providing a suitable plant seed;

b) preparing a suitable adhesive solution;

c) preparing a suitable cross-linked hydrophilic polymer powder or inactive inert powder mixture; and

d) coating the seed with a desired thickness or amount of the cross-linked hydrophilic polymer powder or mixture and adhesive solution.

In a particular embodiment, the method of preparation may also further comprise adding at least one seed amendment material to the cross-linked hydrophilic polymer solution or mixture.

### BRIEF DESCRIPTION OF THE DRAWINGS

FIG. 1 illustrates a perspective view of dry cross-linked hydrophilic polymer coated turf seeds according to an embodiment of the present invention.

FIG. 2 illustrates a perspective view of wet cross-linked hydrophilic polymer coated turf seeds according to an embodiment of the present invention.

FIG. 3 illustrates a graphical view of comparative germination rate over time results of an experimental germination trial of untreated control and cross-linked hydrophilic polymer coated turf seeds according to a further embodiment of the present invention.

FIG. 4 illustrates a graphical view of comparative germination rate over time results of an experimental water stressed germination trial of untreated control and cross-linked hydrophilic polymer coated turf seeds according to a further embodiment of the present invention.

FIG. 5 illustrates a perspective view of wet and dry enzymatically cross-linked hydrophilic cellulose coated tomato seeds according to an embodiment of the present invention.

### DETAILED DESCRIPTION OF SEVERAL EMBODIMENTS OF THE INVENTION

In one embodiment of the present invention, a hydrophilic polymer coated seed is provided comprising a suitable plant seed, coated with suitably thick coating consisting of at least one cross-linked hydrophilic polymer.

In one such embodiment, the cross-linked hydrophilic polymer coating on the coated seed may desirably facilitate at least one of: an increased moisture content surrounding the seed during planting, germination or initial growth of the seed, relative to an uncoated seed, for example. In a particular embodiment, the hydrophilic polymer material may comprise one or more cross-linked hydrophilic hydrogel and/or cellulose materials. In another particular embodiment, the coating on the plant seed may optionally be shaped in any convenient or desired shape, thickness or configuration, such as but not limited to a substantially uniform coating of a suitable desired thickness, in approximately the shape of the plant seed underlying the coating.

In an exemplary embodiment, the cross-linked hydrophilic coating material may comprise at least one suitable cross-linked hydrophilic hydrogel material, such as but not limited to: polyacrylamide, polyacrylate (such as polyhydroxymethylacrylate), polyvinyl alcohol, and sulphurated polystyrene hydrogel materials. In a particular embodiment, the at least one suitable cross-linked hydrophilic hydrogel material may comprise a cross-linked potassium polyacrylate hydrogel. In another particular embodiment, the at least one suitable cross-linked hydrophilic hydrogel material may comprise an enzymatically cross-linked cellulose hydrogel. According to another embodiment, in any of the exemplary embodiments described above or below, the cross-linked hydrophilic polymer coating may comprise at least one suitable hydrophilic hydrogel material which comprises a first polymeric material having polyacrylic acid, and a second polymeric material having a polyglycol other than polyethylene glycol, where the first polymeric material is hydrogen-bonded to the second polymeric material. According to yet another embodiment, in any of the exemplary embodiments described above or below, the cross-linked hydrophilic polymer coating may comprise at least one suitable hydrophilic hydrogel material comprising a polyglycol comprising polytetramethylene ether glycol. In another optional embodiment, in any of the exemplary embodiments described above or below the cross-linked hydrophilic polymer coating may comprise at least one suitable hydrophilic hydrogel material comprising at least one suitable hydrophilic hydrogel material having a bulk porosity of at least 5%. In an alternate embodiment, the coating may optionally comprise at least one cross-linked hydrophilic cellulose material. In another embodiment, the cross-linked hydrophilic polymer coating may optionally comprise at least one suitable adhesive material, such as to provide for improved adhesion of the cross-linked hydrophilic polymer coating material. In one such embodiment, such adhesive materials may be particularly desirable in applications where the hydrophilic polymer coating is applied in a substantially dry or powder form, for example.

In one embodiment, the cross-linked hydrophilic polymer coating may additionally comprise at least one suitable seed amendment material, which may comprise at least one of: a suitable nutrient, fertilizer, pH control, herbicide, pesticide, or fungicide material, for example. In another embodiment, any suitable seed or plant nutrient material may be included in the cross-linked hydrophilic polymer seed coating, such as, but not limited to any suitable: fertilizer, nitrogen/nitrate, potassium, phosphorus, magnesium and/or calcium-containing nutrient materials, for example. In yet another embodiment, any suitable seed or plant pH control material may be included in the cross-linked hydrophilic polymer seed coating, such as but not limited to: acids, acid salts, acid-forming cations (such as sulfur for example), bases, basic salts, base-producing anions. In a further embodiment, any suitable seed and/or plant herbicide, pesticide or fungicide material may be included in the cross-linked hydrophilic polymer seed coating, such as may be suitable for countering any weed, pest or fungus found in a particular seed, storage, planting or soil environment desired for application of the cross-linked hydrophilic polymer coated seed, for example.

In a further embodiment of the invention, the seed coated with the cross-linked hydrophilic polymer seed coating may comprise any suitable plant seed. In one such embodiment, potentially suitable plant seeds, may comprise but are limited to: crop (such as agronomically important crops including but not limited to berries such as strawberries, tomatoes, cruciferous crops such as broccoli and cauliflower, lettuce and other greens, peppers, grains, legumes), turf or grass, ornamental plant, flower, tree, shrub, bush, fruit, or other suitable seed.

In one embodiment of the present invention, the above-described cross-linked hydrophilic polymer coated seed may desirably provide for an easily handled and stored coated seed. In another embodiment of the invention, the above-described cross-linked hydrophilic polymer coated seed may desirably provide for at least one of increased germination rate, increased germination uniformity and increased germination vigor. In yet another embodiment of the invention, the above-described cross-linked hydrophilic polymer coated seed may desirably provide for increased seed moisture content or moisture content surrounding the seed during germination.

In another embodiment of the present invention, a method of preparation of a cross-linked hydrophilic polymer coated seed is provided, wherein the method comprises the steps of:

a) providing a suitable plant seed;

b) preparing a suitable cross-linked hydrophilic polymer powder, solution or mixture;

c) coating the seed with a suitable or desired thickness of the cross-linked hydrophilic polymer powder, solution or mixture; and

d) drying the coated seed to a suitable or desired moisture content of the cross-linked hydrophilic polymer coating.

In a further embodiment of the present invention, a method of preparation of a cross-linked hydrophilic polymer coated seed is provided, wherein the method comprises the steps of:

a) providing a suitable plant seed;

b) preparing a suitable adhesive solution;

c) preparing a suitable cross-linked hydrophilic polymer powder or inactive inert powder mixture; and

d) coating the seed with a desired thickness or amount of the cross-linked hydrophilic polymer powder or mixture and adhesive solution.

In an optional embodiment, the method of preparation may comprise preparing first and second suitable adhesive solutions, and a first cross-linked hydrophilic polymer powder and a second inactive inert powder. In one such embodiment, the method may also comprise coating the seed with a desired thickness or amount of the first adhesive solution and first cross-linked hydrophilic polymer powder. The method may also further comprise then coating the seed with a desired thickness or amount of the second adhesive solution and second inactive inert powder. In another optional embodiment, the method may comprise a plurality of steps comprising coating the seed with a desired thickness or amount of at least one of the cross-linked hydrophilic polymer powder, or inactive inert powder mixture, for example. In yet a further embodiment, the method may also further comprise drying the coated seed to a suitable or desired moisture content of the cross-linked hydrophilic polymer coating.

In a particular embodiment, the method of preparation may also further comprise adding at least one seed amendment material to the cross-linked hydrophilic polymer powder, solution or mixture. In a further particular embodiment, the step of coating the seed with a suitable or desired thickness of the cross-linked hydrophilic polymer may comprise one or more of wet or dry coating steps, and combinations thereof.

In a further embodiment of the present invention, a cross-linked hydrophilic hydrogel polymer coated seed may be provided comprising a seed, a first coating comprising a cross-linked hydrophilic polymer, and a second coating comprising an inactive inert material on top of the first coating. In another such embodiment, the cross-linked hydrophilic hydrogel polymer coated seed may further comprise a plurality of first coatings comprising a cross-linked hydrophilic polymer. In yet a further embodiment, at least one of the first and second coatings may additionally comprise an adhesive material.

### EXPERIMENTAL EXAMPLES ACCORDING TO SEVERAL EMBODIMENTS

### Example 1

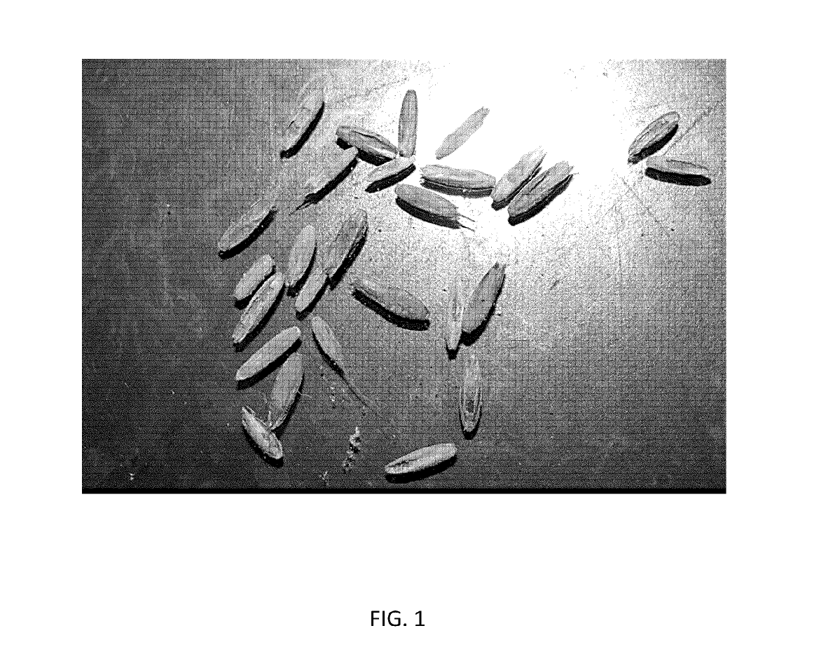

In a first experimental example according to an embodiment of the present invention, commercially available turf or grass seeds (such as the Scotts Turfbuilder™ seed lot # 13010315 used in this example) were coated with a cross-linked hydrophilic polymer, specifically an exemplary cross-linked potassium polyacrylate hydrophilic hydrogel polymer, available from mOasis Inc. of Union City, Calif., USA, as BountiGel™ hydrogel. After coating, turf seeds coated with the potassium polyacrylate hydrophilic polymer were allowed to germinate, along with uncoated control seeds, in warm and water stressed germination tests, as described in detail below. FIG. 1 illustrates a perspective view of dry cross-linked hydrophilic polymer coated turf seeds according to an embodiment of the present invention.

In the first experimental example according to an embodiment of the invention, a rotary seed coating machine was used, in particular an Aginnovation Rotary-6 seed coating machine available from Aginnovation LLC, of Walnut Grove, Calif., USA, for example. Two adhesive solutions were prepared for facilitating coating of the seeds with the cross-linked hydrophilic polymer hydrogel. A first adhesive Solution A was prepared as a 10% (w/v) solution of polyvinylpyrrolidone (obtained as PVP40 available from Sigma Aldrich of St. Louis, Mo., USA) in dichloromethane (270997 from Sigma Aldrich). A second adhesive Solution B was prepared as a 20% (w/v) solution of polyvinyl acetate (189480 from Sigma Aldrich) in dichloromethane (270997 from Sigma Aldrich). Two coating powder formulations were prepared for coating on the seeds. A first cross-linked hydrophilic hydrogel polymer Powder Formulation 1 was prepared by blending 5 g of cross-linked potassium polyacrylate hydrophilic hydrogel polymer powder (BountiGel™ hydrogel polymer powder from mOasis Inc.) with 5 g of talc powder (243604 from Sigma Aldrich). A second coating Powder Formulation 2 was prepared by blending 1 g of potato starch powder (S4251 from Sigma Aldrich) with 9 g of talc powder (243604 from Sigma Aldrich).

The exemplary turf seeds were then coated using the rotary seed coating machine at a rotary speed setting of about 300-500 rpm. A 200 g sample of turf seeds (Scotts Turfbuilder™ seed lot # 13010315) were loaded into the rotary chamber of the seed coating machine. A 6 mL volume of adhesive solution A was added to the seeds in the chamber via a spinning atomizing disk at a rate of 2 mL/minute. Following the addition of adhesive Solution A, a 3 g quantity of Powder Formulation 1 was added to the seeds at a rate of 2 g/minute. Then a second exemplary 6 mL volume of adhesive solution A was added to the seeds in the chamber via the atomizing disk at a rate of 2 mL/minute, followed by another exemplary 3 g of Powder Formulation 1 at a rate of 2 g/minute. Then an exemplary 6 mL volume of adhesive Solution B was added to the seeds in the chamber via a spinning atomizing disk at a rate of 2 mL/minute, followed by an exemplary 2 g quantity of Powder Formulation 2 which was added to the seeds at a rate of 2 g/minute.

Following the above coating procedure, the coated turf seeds were transferred to a stainless steel plate (exemplary 30 cm×45 cm stainless plate) and allowed to dry under a fume hood for about 30 minutes. An example of the resulting exemplary coated turf seeds are shown in the perspective view of dry cross-linked hydrophilic polymer coated turf seeds of FIG. 1.

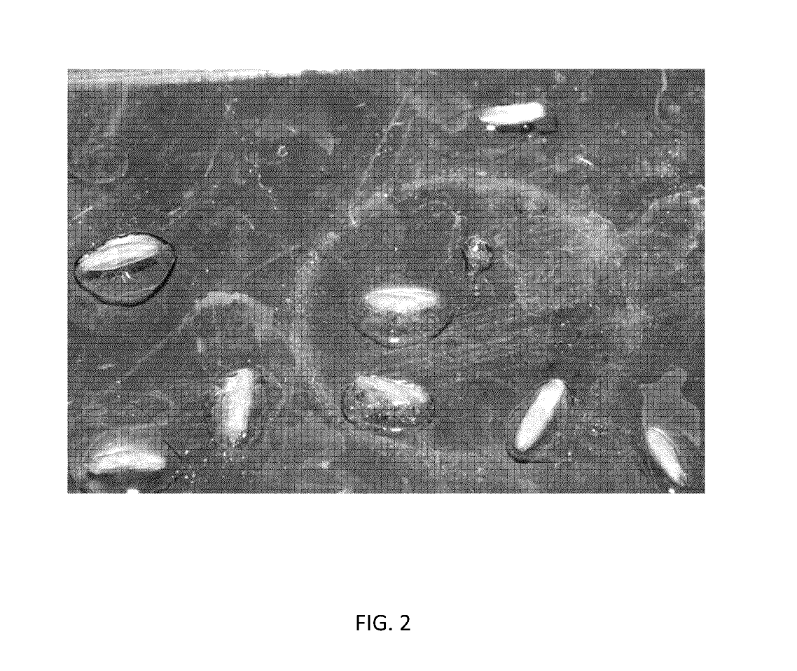

The cross-linked hydrophilic polymer coated turf seeds resulting from the above experimental embodiment of the present invention were then evaluated for germination performance according to two experimental germination tests using varying levels of hydration of the exemplary cross-linked hydrophilic polymer coated turf seeds and untreated and non-coated control turf seeds (also Scotts Turfbuilder™ seed lot # 13010315). FIG. 2 illustrates a perspective view of exemplary wet or hydrated cross-linked hydrophilic polymer coated turf seeds according to an embodiment of the present invention.

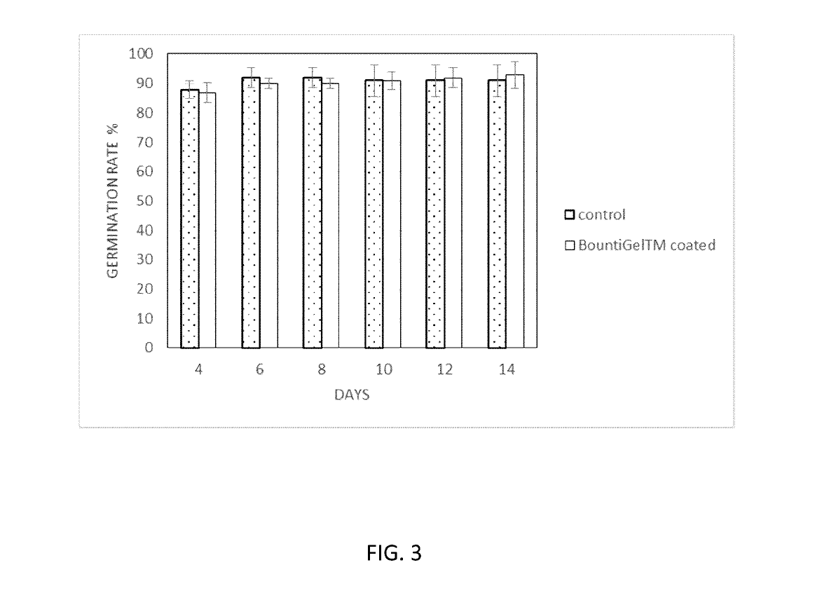

In a first warm seed germination test, 100 exemplary cross-linked hydrophilic polymer coated turf seeds prepared according to the above-described experimental coating procedure and 100 untreated non-coated control turf seeds were each placed on top of a folded paper substrate (an exemplary 23.5 cm×23.5 cm paper towel) saturated with 15 mL of water, and then placed inside an incubator chamber at approximately 25° C. for a period of 14 days. The seeds were monitored during the incubation period and the number of seeds that had germinated in each of the treated coated seed and untreated control seed groups were counted and recorded over the course of the 14 day incubation period. The results of the exemplary warm seed germination test are shown in the graphical view illustrated in FIG. 3, showing the comparative germination rate over time results of the exemplary experimental warm germination trial, according to a further embodiment of the present invention.

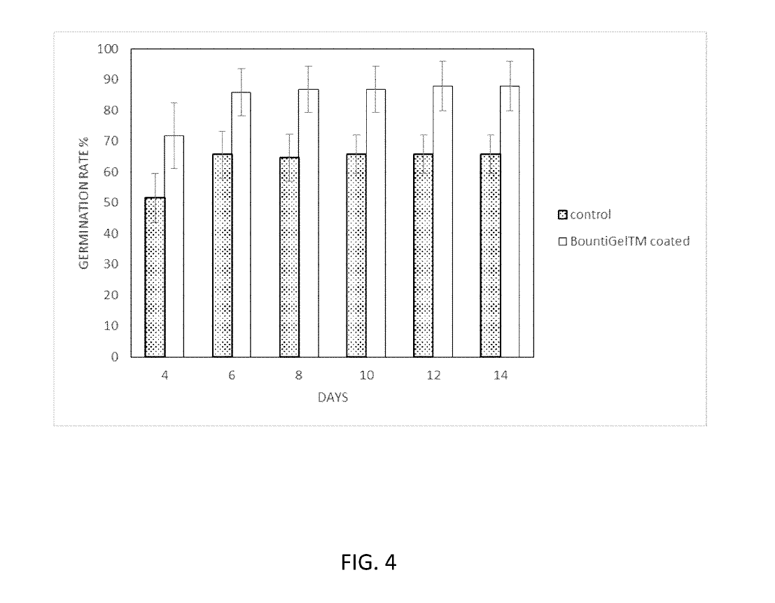

In a second water stressed seed germination test, 100 exemplary cross-linked hydrophilic polymer coated turf seeds prepared according to the above-described experimental coating procedure and 100 untreated non-coated control turf seeds were each placed on top of a folded paper substrate (an exemplary 23.5 cm×23.5 cm paper towel) to which only 3.75 mL of water was added, representing an experimental water stressed germination condition, and then placed inside an incubator chamber at approximately 25° C. for a period of 14 days. The seeds were monitored during the incubation period and the number of seeds that had germinated in each of the treated coated seed and untreated control seed groups were counted and recorded over the course of the 14 day incubation period. The results of the exemplary water stressed seed germination test are shown in the graphical view illustrated in FIG. 4, showing the comparative germination rate over time results of the exemplary experimental water stressed germination trial, according to another embodiment of the present invention.

### Experimental Results Of Warm And Water Stressed Germination Trials

As shown in FIG. 3 in the graphical view of comparative germination rate over time results of an experimental warm germination trial of untreated control and cross-linked hydrophilic polymer coated turf seeds according to an embodiment of the invention, the treated cross-linked hydrophilic polymer coated seeds did not have a statistically differentiable difference in germination rate in comparison with the untreated control seeds. As the warm germination trial represented ideal and unstressed germination conditions, this result indicates that the experimental coating process used to produce the cross-linked hydrophilic polymer coated turf seeds according to an embodiment of the invention did not have an impact on germination rates under ideal conditions. Therefore, this result indicates that the experimental coating process according to an embodiment of the invention did not harm or reduce the germination of the seed, compared to the control seeds, which is desirable for determining a useful seed coating procedure according to an embodiment of the invention.

As shown in FIG. 4 in the graphical view of comparative germination rate over time results of an experimental water stressed germination trial of untreated control and cross-linked hydrophilic polymer coated turf seeds according to a further embodiment of the present invention, the treated cross-linked hydrophilic polymer coated seeds resulted in an improved germination rate (i.e. a greater number of germinated seeds) at each recorded measurement interval, in comparison with the untreated control seeds. As the water stressed germination trial represents germination performance under water stressed or limited water germination conditions, this result indicates that the experimental coating process used to produce the cross-linked hydrophilic polymer coated turf seeds according to an embodiment of the invention provides for a desirable improvement in germination rate and indicates a beneficial water retaining effect of the cross-linked hydrophilic polymer coating and method of coating applied to the turf seeds according to an embodiment of the invention.

### Example 2

In a second experimental example according to an embodiment of the present invention, commercially available corn seeds were coated with a cross-linked hydrophilic polymer, specifically an exemplary cross-linked potassium polyacrylate hydrophilic hydrogel polymer, available from mOasis Inc. of Union City, Calif., USA, as BountiGel™ hydrogel. After coating, corn seeds coated with the potassium polyacrylate hydrophilic polymer were subjected to a standard warm germination test as detailed below.

In the second experimental example according to an embodiment of the invention, an Aginnovation Rotary-6 rotary seed coating machine available from Aginnovation LLC, of Walnut Grove, Calif., USA, was used for coating the corn seeds. Two adhesive solutions were prepared for facilitating coating of the corn seeds with the cross-linked hydrophilic polymer hydrogel. A first adhesive Solution A was prepared as a 20% (w/v) solution of polyvinylpyrrolidone (obtained as PVP40 available from Sigma Aldrich of St. Louis, Mo., USA) in dichloromethane (270997 from Sigma Aldrich). A second adhesive Solution B was prepared as a 20% (w/v) solution of polyvinyl acetate (189480 from Sigma Aldrich) in dichloromethane (270997 from Sigma Aldrich). Two coating powder formulations were prepared for coating on the seeds. A first cross-linked hydrophilic hydrogel polymer Powder Formulation 1 was prepared by blending 5 g of cross-linked potassium polyacrylate hydrophilic hydrogel polymer powder (BountiGel™ hydrogel polymer powder from mOasis Inc.) with 5 g of talc powder (243604 from Sigma Aldrich). A second coating Powder Formulation 2 was prepared by blending 1 g of potato starch powder (S4251 from Sigma Aldrich) with 9 g of talc powder (243604 from Sigma Aldrich).

The exemplary corn seeds were then coated using the rotary seed coating machine at a rotary speed setting of about 200-600 rpm. A 200 g sample of corn seeds (particularly Pioneer P0987 available from Pioneer Hi-Bred International, Inc., of Johnston, Iowa, USA) were loaded into the rotary chamber of the seed coating machine. A 6 mL volume of adhesive solution A was added to the seeds in the chamber via a spinning atomizing disk at a rate of 2 mL/minute. Following the addition of adhesive Solution A, a 3 g quantity of Powder Formulation 1 was added to the seeds at a rate of 2 g/minute. Then a second exemplary 6 mL volume of adhesive solution A was added to the seeds in the chamber via the atomizing disk at a rate of 2 mL/minute, followed by another exemplary 3 g of Powder Formulation 1 added at a rate of 2 g/minute. Then an exemplary 5 mL volume of adhesive Solution B was added to the seeds in the chamber via a spinning atomizing disk at a rate of 2 mL/minute, followed by an exemplary 2 g quantity of Powder Formulation 2 which was added to the seeds at a rate of 2 g/minute. Following the above coating procedure, the coated corn seeds were transferred to a stainless steel plate (exemplary 30 cm×45 cm stainless plate) and allowed to dry under a fume hood for about 30 minutes.

The cross-linked hydrophilic polymer coated corn seeds resulting from the above experimental embodiment of the present invention were then evaluated for germination performance in comparison to uncoated control corn seeds, according to a standardized warm germination test conducted by the Iowa State University Seed Testing Laboratory using accepted standard germination test protocols (such as established by NSHS-National Seed Health System, ISTA—International Seed Testing Association, and AOSA—Association of Official Seed Analysts).

In the standard warm germination test, the toxicity of the cross-linked hydrophilic polymer coating on the coated corn seeds was tested in comparison to untreated and non-coated corn seeds from the same source. In the standard germination test, a minimum of 400 cross-linked hydrophilic polymer coated corn seeds prepared according to the above-described experimental coating procedure and 400 untreated non-coated control corn seeds were each placed on approved test substrates (such as rolled brown paper towels for 8 reps of 50 seeds, blue blotter paper, crepe cellulose paper (Kimpak®), or Kimpak® covered with sand). Standard germination tests for corn are then typically tested for germination at approximately 25° C. for a period of 7 days. The seeds were monitored during the incubation period and the number of seeds that had germinated in each of the treated coated corn seeds and untreated control seed groups were counted and recorded over the course of the standard warm germination test.

### Experimental Results Of Standard Warm Germination Test

The results of the above-described standard warm germination test performed by the Iowa State University Seed Testing Laboratory using accepted standard germination test protocol on the treated cross-linked hydrophilic polymer coated corn seeds prepared as described above show that the cross-linked hydrophilic polymer coating of the corn seeds did not have a statistically differentiable difference in germination rate in comparison with the untreated control seeds under standard warm germination conditions. In particular, the results of the standard warm germination test showed identical 98% germination rates for both the treated coated corn seeds and the untreated non-coated control seeds. This result indicated that the experimental coating process used to produce the cross-linked hydrophilic polymer coated corn seeds according to an embodiment of the invention did not have an impact on germination rates under standard warm germination test conditions. Therefore, this result indicates that the experimental coating process according to an embodiment of the invention did not harm or reduce the germination of the seed, which is desirable for determining a useful seed coating procedure according to an embodiment of the invention.

### Example 3

In a third experimental example according to an embodiment of the present invention, commercially available broccoli seeds were coated with a cross-linked hydrophilic polymer, specifically an exemplary cross-linked potassium polyacrylate hydrophilic hydrogel polymer, available from mOasis Inc. of Union City, Calif., USA, as BountiGel™ hydrogel. In other alternative embodiments, other suitable small vegetable seeds may be used for coating with the exemplary cross-linked potassium polyacrylate hydrophilic hydrogel polymer coatings according to the below coating methods.

In the third experimental example according to an embodiment of the invention, an Aginnovation Rotary-6 rotary seed coating machine available from Aginnovation LLC, of Walnut Grove, Calif., USA, was used for coating the exemplary broccoli seeds. Two adhesive solutions were prepared for facilitating coating of the broccoli seeds with the cross-linked hydrophilic polymer hydrogel. A first adhesive Solution A was prepared as a 10% (w/v) solution of polyvinylpyrrolidone (obtained as PVP40 available from Sigma Aldrich of St. Louis, Mo., USA) in dichloromethane (270997 from Sigma Aldrich). A second adhesive Solution B was prepared as a 20% (w/v) solution of polyvinyl acetate (189480 from Sigma Aldrich) in dichloromethane (270997 from Sigma Aldrich). Two coating powder formulations were prepared for coating on the broccoli seeds. A first cross-linked hydrophilic hydrogel polymer Powder Formulation 1 was prepared by blending 5 g of cross-linked potassium polyacrylate hydrophilic hydrogel polymer powder (BountiGel™ hydrogel polymer powder from mOasis Inc.) with 5 g of talc powder (243604 from Sigma Aldrich). A second coating Powder Formulation 2 was prepared by blending 1 g of potato starch powder (S4251 from Sigma Aldrich) with 9 g of talc powder (243604 from Sigma Aldrich).

The exemplary broccoli seeds were then coated using the rotary seed coating machine at a rotary speed setting of about 300-500 rpm. A 50 g sample of broccoli seeds (particularly Calabrese untreated broccoli seeds available from Eden Brothers of Asheville, N.C., USA) were loaded into the rotary chamber of the seed coating machine. A 2 mL volume of adhesive solution A was added to the seeds in the chamber via a spinning atomizing disk at a rate of 2 mL/minute. Following the addition of adhesive Solution A, a 2 g quantity of Powder Formulation 1 was added to the seeds at a rate of 2 g/minute. Then a second exemplary 2 mL volume of adhesive solution A was added to the seeds in the chamber via the atomizing disk at a rate of 2 mL/minute, followed by another exemplary 2 g of Powder Formulation 1 added at a rate of 2 g/minute. Then an exemplary 3 mL volume of adhesive Solution B was added to the seeds in the chamber via a spinning atomizing disk at a rate of 2 mL/minute, followed by an exemplary 2 g quantity of Powder Formulation 2 which was added to the seeds at a rate of 2 g/minute. Following the above coating procedure, the coated broccoli seeds were transferred to a stainless steel plate (exemplary 30 cm×45 cm stainless plate) and allowed to dry under a fume hood for about 30 minutes.

The cross-linked hydrophilic polymer coated broccoli seeds resulting from the above experimental embodiment of the present invention were then evaluated for consistency of coating, and the cross-linked hydrophilic polymer coating was found to be desirably substantially even.

### Example 4

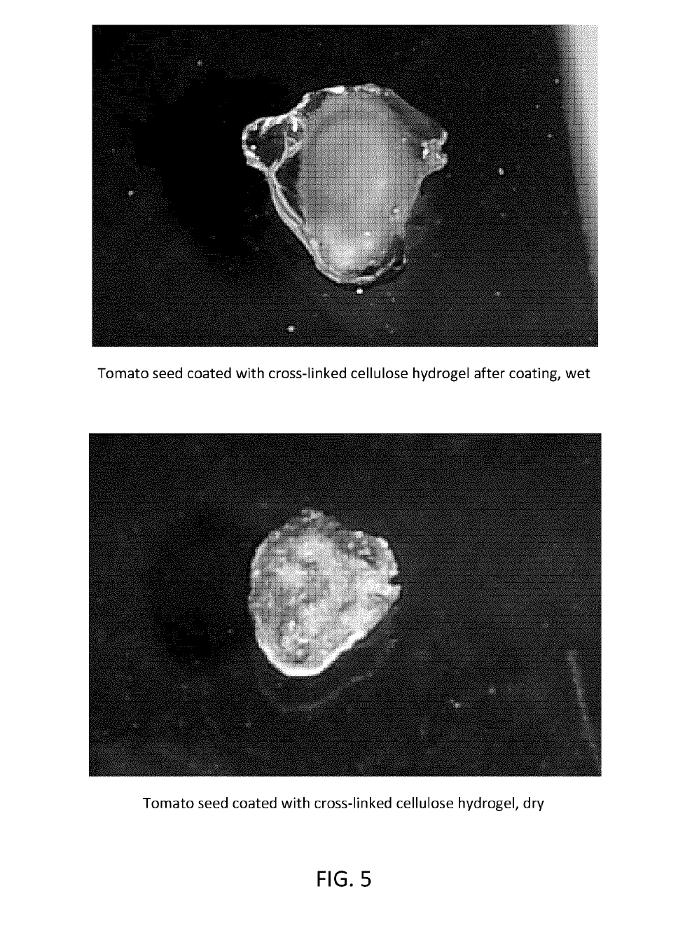

In a fourth experimental example according to an embodiment of the present invention, exemplary tomato seeds (Burpee Super Beefsteak Tomato seeds, available from W. Atlee Burpee & Co., Warminster, Pa., USA) were coated with a cross-linked hydrophilic polymer, specifically a cross-linked hydrophilic cellulose polymer cross-liked with an enzymatic cross-linker. FIG. 5 illustrates a perspective view of wet and dry enzymatically cross-linked hydrophilic cellulose coated tomato seeds according to an embodiment of the present invention. In other alternative embodiments, other suitable vegetable seeds may be used for coating with the exemplary cross-linked cellulosic hydrophilic hydrogel coatings according to the below coating methods, for example.

In this fourth example, enzymatically cross-linked polymers are applied to exemplary tomato seeds to form a cross-linked hydrophilic polymer seed coating according to an embodiment of the present invention. According to one embodiment, this enzymatic cross linking method is advantageously environmentally friendly. An enzymatically cross-linked cellulosic hydrogel is formed within approximately 1 minute by mixing a polymer solution, a cross-linking enzyme (peroxidase), and enzyme substrate (hydrogen peroxide) according to an embodiment of the invention. In one such embodiment, enzymatic cross-linkable polymers are synthesized and then applied to form a hydrogel coating around seeds for the purpose of providing a cross-linked hydrophilic hydrogel coated seed.

The following steps were performed to synthesize an exemplary tyramine conjugated sodium carboxymethylcellulose hydrogel material by means of a carbodiimide chemistry:

1. 2.0 g of sodium carboxymethylcellulose was dissolved in 90 mL of water.

2. 10 mL of 500 mM IVIES pH 6.5 buffer was added to the solution.

3. 1.0 g of tyramine hydrochloride, 0.74 g of N-(3-dimethylaminopropyl)-N′-ethylcarbodiimide hydrochloride, and 0.22 g of N-hydroxysuccinimide were added to the solution.

4. The reaction was carried out at room temperature for 24 hours with constant stirring.

5. The solution pH was adjusted to 7.5 by addition of 5.0 M KOH solution. The reaction solution was stirred for another 2 hours.

6. The reaction product was precipitated by adding 300 mL methanol. The white precipitation was collected by vacuum filtration. The product was washed with 200 mL of methanol twice. Then the resulting white powder was dried in an oven at 50 degree C. for 12 hours.

7. The product, tyramine conjugated cellulose (Tyr-Cellulose), was collected as a white solid.

According to one embodiment of the invention, exemplary tomato seeds were then coated, providing a coating of the exemplary tyramine conjugated cellulose as described below:

Tomato seeds (Burpee Super Beefsteak Tomato seeds, available from W. Atlee Burpee & Co., Warminster, Pa., USA) were distributed to a 96-well plate at one seed per well. A polymer solution was prepared by dissolving 0.1 g Tyr-Cellulose in 5 mL water containing 20 mM phosphate buffer at room temperature. Horseradish peroxidase (HRP) was then added to the Tyr-Cellulose solution to the final concentration of 5 unit/mL. The resulting polymer solution was dispensed onto the seeds in the plate wells at 0.1 mL per well. To initiate the crosslinking reaction, hydrogen peroxide (50 mM final concentration) was added to the Tyr-Cellulose/HRP polymer mixture in each well. The cross linking reaction was substantially immediate as evidenced by the observed viscosity increasing drastically. The hydrogel formed in the wells within about 10 seconds around the exemplary tomato seeds, providing a wet cellulose hydrogel coating. The coated tomato seeds were then dried under a fume hood for 24 hours to provide a dried tomato seed coated with a cross-linked hydrophilic cellulose hydrogel coating, according to an embodiment of the present invention, and as shown in FIG. 5.

The exemplary embodiments herein described, including what is described in the Abstract, are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, various equivalent alterations and modifications are possible in the practice of this invention without departing from the scope of the disclosure.

Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Further, the described features, structures, or characteristics of the present disclosure may be combined in any suitable manner in one or more embodiments. In this Detailed Description of the Invention, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure.

The scope of the present disclosure fully encompasses other embodiments and is to be limited, accordingly, by nothing other than the appended claims, wherein any reference to an element being made in the singular is intended to mean “one or more”, and is not intended to mean “one and only one” unless explicitly so stated. All structural and functional equivalents to the elements of the above-described preferred embodiment and additional embodiments are hereby expressly incorporated by reference and are intended to be encompassed by the present claims. Moreover, no requirement exists for an apparatus or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, are also encompassed by the present disclosure.

What is claimed is:

1. A hydrophilic polymer coated seed comprising a plant seed, and a first coating of at least one of: a cross-linked hydrophilic hydrogel polymer and a cross-linked hydrophilic cellulose material.

2. The hydrophilic polymer coated seed according to claim 1, wherein the first coating comprises a cross-linked potassium polyacrylate hydrophilic hydrogel.

3. The hydrophilic polymer coated seed according to claim 1, wherein the first coating comprises an enzymatically cross-linked cellulose hydrophilic hydrogel.

4. The hydrophilic polymer coated seed according to claim 1, wherein the first coating additionally comprises at least one adhesive material.

5. The hydrophilic polymer coated seed according to claim 1, additionally comprising a second coating comprising at least one inert material.

6. The hydrophilic polymer coated seed according to claim 5, wherein the second coating additionally comprises at least one adhesive material.

7. A method of preparation of a cross-linked hydrophilic polymer coated seed, wherein the method comprises the steps of:
a) providing a plant seed;
b) preparing a cross-linked hydrophilic polymer mixture;
c) coating the seed with the cross-linked hydrophilic polymer mixture; and
d) drying the coated seed to a suitable or desired moisture content of the cross-linked hydrophilic polymer coating.

8. The method of preparation of a cross-linked hydrophilic polymer coated seed according to claim 7, wherein the method additionally comprises the step of adding at least one seed amendment material to the cross-linked hydrophilic polymer mixture.

9. The method of preparation of a cross-linked hydrophilic polymer coated seed according to claim 7, wherein the polymer mixture comprises a solution.

10. The method of preparation of a cross-linked hydrophilic polymer coated seed according to claim 7, wherein the polymer mixture comprises a powder.

11. The method of preparation of a cross-linked hydrophilic polymer coated seed according to claim 7, wherein the cross-linked hydrophilic polymer mixture comprises a cross-linked potassium polyacrylate hydrophilic hydrogel.

12. The method of preparation of a cross-linked hydrophilic polymer coated seed according to claim 7, wherein the cross-linked hydrophilic polymer mixture comprises an enzymatically cross-linked cellulose hydrophilic hydrogel.

13. A method of preparation of a cross-linked hydrophilic polymer coated seed, wherein the method comprises the steps of:
a) providing a plant seed;
b) preparing an adhesive solution;
c) preparing a cross-linked hydrophilic polymer mixture; and
d) coating the seed with the cross-linked hydrophilic polymer mixture and adhesive solution.

14. The method of preparation of a cross-linked hydrophilic polymer coated seed according to claim 13, additionally comprising the step of coating the seed with a second coating comprising an inert material and an adhesive solution.

15. The method of preparation of a cross-linked hydrophilic polymer coated seed according to claim 13, wherein the polymer mixture comprises a solution.

16. The method of preparation of a cross-linked hydrophilic polymer coated seed according to claim 13, wherein the polymer mixture comprises a powder.

17. The method of preparation of a cross-linked hydrophilic polymer coated seed according to claim 13, wherein the cross-linked hydrophilic polymer mixture comprises a cross-linked potassium polyacrylate hydrophilic hydrogel.

18. The method of preparation of a cross-linked hydrophilic polymer coated seed according to claim 13, wherein the method additionally comprises the step of adding at least one seed amendment material to the cross-linked hydrophilic polymer mixture.
